(19) United States
(12) Patent Application Publication
(10) Pub. No.: US 2009/0048714 A1
(43) Pub. Date: Feb. 19, 2009

(54) CONTROL SYSTEM AND METHOD FOR CONTROLLING AN AIR HANDLING FAN FOR A VENT HOOD

(75) Inventor: Nicholas Roth Hanawalt, Troy, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: MAXITROL COMPANY, Southfield, MI (US)

(21) Appl. No.: 12/192,320

(22) Filed: Aug. 15, 2008

Related U.S. Application Data
(60) Provisional application No. 60/956,548, filed on Aug. 17, 2007.

(51) Int. Cl. G05B 15/00; F24C 15/20; G05D 23/00

(52) U.S. Cl. 700/275; 126/299 D; 700/300

(57) ABSTRACT

A system and method of controlling a variable speed air handling fan for a vent hood includes a temperature sensor and a processor. Speed setpoints and a deadband range are received from a user by the processor. The processor computes deadband setpoints and receives a temperature from the temperature sensor. The processor is in communication with a motor controller for controlling the speed of the fan. The processor changes the speed of the fan when the temperature rises above a certain setpoint. However, the processor will not change the speed of the fan back to its previous speed until the temperature falls below the deadband setpoint that corresponds to the certain setpoint.

### CROSS REFERENCE TO RELATED APPLICATION

This application claims the benefit of U.S. Provisional Application No. 60/956,548 filed Aug. 17, 2007.

### BACKGROUND OF THE INVENTION

1. Field of the Invention

The subject invention relates to a system and a method for operating air handling fans for vent hoods.

2. Description of the Related Art

Ventilation hoods, i.e., vent hoods, are commonly used in buildings to ventilate air to the outside. These vent hoods are often installed in kitchens above cooking ranges, both in commercial and residential applications. As such, these vent hoods exhaust not only uncomfortably warm air, but also the smoke that often accompanies food preparation.

In the past, these vent hoods were mostly manually operated. That is, a user would turn a fan on using a switch or button and turn it off when complete. Unfortunately, these manually operated vent hoods are often left on, even when not needed, and therefore wasted energy. Furthermore, a user, e.g., a cook, are often too busy with other tasks to turn the vent hood on or increase its speed from low to high. Moreover, automatically operated vent hoods often switch erratically between different speeds based on a sudden cooling that occurs when the fan is turned on or is increased form a low speed to a high speed.

Therefore, there remains an opportunity for a method for operating a vent hood which is automatically operated and operates in a non-erratic fashion.

### SUMMARY OF THE INVENTION AND ADVANTAGES

The subject invention provides a method of controlling an air handling fan for a vent hood where the fan has at least a first speed and a second speed. The method includes the step of receiving a first temperature setpoint from a user. The first temperature setpoint corresponds to a temperature at which the speed of the fan is changed from the first speed to the second speed. The method further includes the step of storing the first temperature setpoint in a memory. The method further includes receiving a first temperature deadband range from a user. The first temperature deadband range is then stored in the memory. The method continues with the step of obtaining a temperature of air in the vent hood. The temperature of air is then compared to the first temperature setpoint. The speed of the air handling fan is changed from the first speed to the second speed in response to the temperature of air being greater than the first temperature setpoint. The method further includes the step of computing a first deadband temperature setpoint based on the first temperature setpoint and the temperature deadband range. The method also includes the step of changing the speed of the air handling fan from the second speed to the first speed in response to the temperature of air being less than the first deadband temperature setpoint.

By utilizing the deadband range to computer the deadband setpoint, the subject invention provides a method that helps eliminate repetitive, unnecessary, and sometimes harmful switching of the speed of the fan. As the switching of the motor speed may cause damage to various electrical components, such as relays and transistors, the method serves to prevent quick switching of the fan back to the first speed. The method also promotes proper operation of electrical components, e.g., preventing chattering and buzzing relays.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a block diagram of a control system controlling an air handling fan for a vent hood;

FIG. 2A is an electrical schematic diagram showing a processor and temperature sensing circuit of a preferred embodiment of the control system;

FIG. 2B is an electrical schematic diagram showing an input device of the preferred embodiment of the control system;

FIG. 2C is an electrical schematic diagram showing an output device of the preferred embodiment of the control system;

FIG. 2D is an electrical schematic diagram showing a power circuit of the preferred embodiment of the control system; and

FIG. 2E is an electrical schematic diagram showing output interface circuits of the preferred embodiment of the control system.

### DETAILED DESCRIPTION OF THE INVENTION

Referring to the Figures, wherein like numerals indicate corresponding parts throughout the several views, a control system 10 is shown for controlling an air handling fan 12 for a vent hood 14. The vent hood 14 may be positioned in a kitchen, particularly above a cooking surface. An electric motor 16 operatively connected to the fan 12 for turning the fan 12, as is well known to those skilled in the art. The fan 12 generates an airflow to move air though the vent hood 14 and, typically, to exhaust the air to the atmosphere.

A motor controller 18 is electrically connected to the electric motor 16 for controlling the application of electric current to the electric motor 16. In the preferred embodiment, the motor controller 18 is a variable speed drive capable of operating the motor 16 at a variety of speeds. Consequently, the speed of the fan 12 and the rate of air flow generated by the fan 12, are also variable. More preferably, the motor controller 18 is a variable frequency drive (VFD) as is well known to those skilled in the art.

In the preferred embodiment, the fan 12 is operated at a first speed, a second speed, or a third speed. The first speed is “off”, where no electricity is applied to the motor 16 to turn the fan 12. The second speed is “low”, where the motor 16 and fan 12 generate an airflow. The third speed is “high”, where the motor 16 is operated at a maximum, i.e., full speed to generate more airflow than at the second speed. Of course, the fan may be operated at different speed definitions in alternative embodiments than those outlined above.

The control system 10 includes a processor 20 in communication with the motor controller 18 for controlling operation of the motor controller 18. In the preferred embodiment, the processor 20 is a microprocessor-based device. More specifically, the processor 20 is implemented with an MSP430F423 microcontroller manufactured by Texas Instruments, headquartered in Dallas, Tex. Of course, other suitable model of microcontrollers or other devices may be suitable to perform the functions of the processor 20.

The control system 10 also includes an analog-to-digital converter 22 (ADC). The ADC 22 is in communication with the processor 20 for providing digital data to the processor 20 corresponding to an analog signal. In the preferred embodiment, the ADC 22 is integrated with the processor 20. That is, the microcontroller includes a built-in ADC 22. However, those skilled in the art realize that the ADC 22 may be an independent component, separate from the processor 20.

A temperature sensing circuit 24 is electrically connected to the ADC 22. The temperature sensing circuit 24 provides a temperature to the ADC 22, and accordingly, to the processor 20. The processor may then control operation of the motor controller 18 based on temperature, as described in greater detail below.

The temperature sensing circuit 24 includes a temperature sensor 26. The temperature sensor 26 may be mounted in the vent hood 14 or other suitable locations. In the preferred embodiment, the temperature sensor 26 is implemented as a resistance temperature detector (RTD) 28. As is known to those skilled in the art, the electrical resistance of the RTD 28 varies based on its temperature. Of course, in alternate embodiments, the temperature sensor 26 may be implemented with other devices, including, but not limited to, a thermocouple.

The temperature sensing circuit 24 of the preferred embodiment also includes a constant current circuit 30. The constant current circuit 30 is electrically connected to the RTD 28 and provides a constant current to the RTD 28. As the current to the RTD 28 is held constant, the voltage drop across the RTD 28 will also vary according to the temperature of the RTD 28. The RTD 28 is electrically connected to the ADC 22 such that the ADC 22 translates the voltage drop across the RTD 28 into the temperature of the RTD 28.

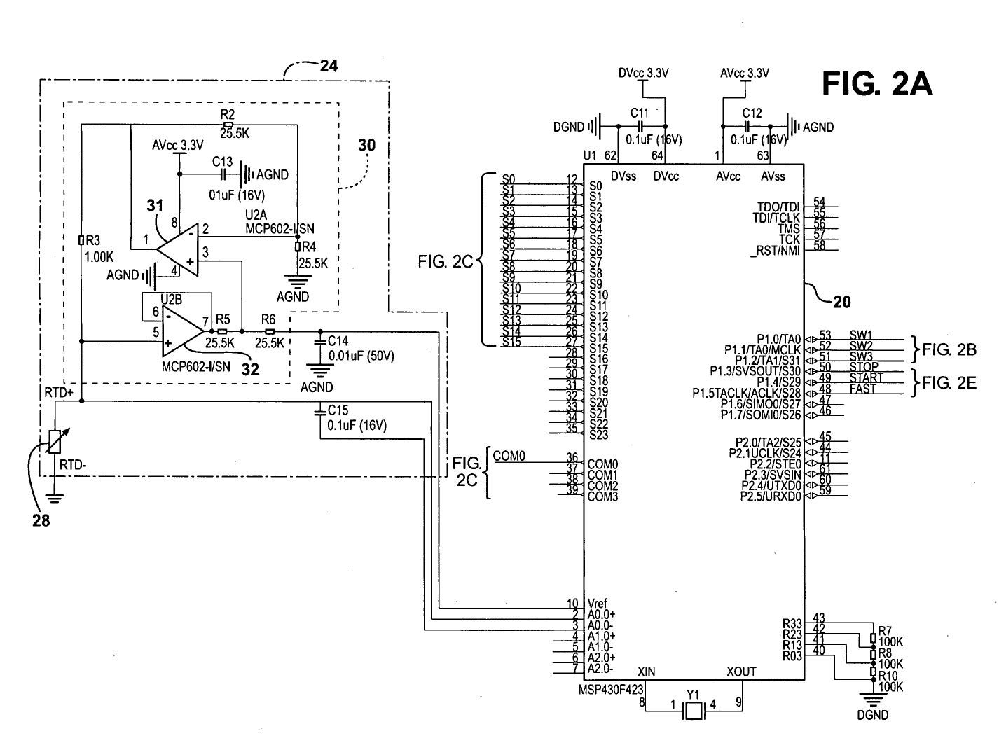

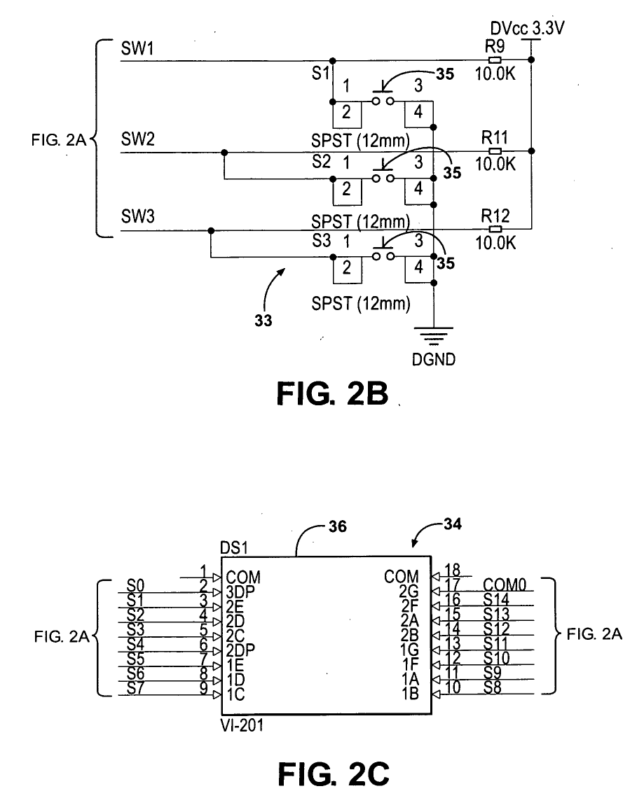

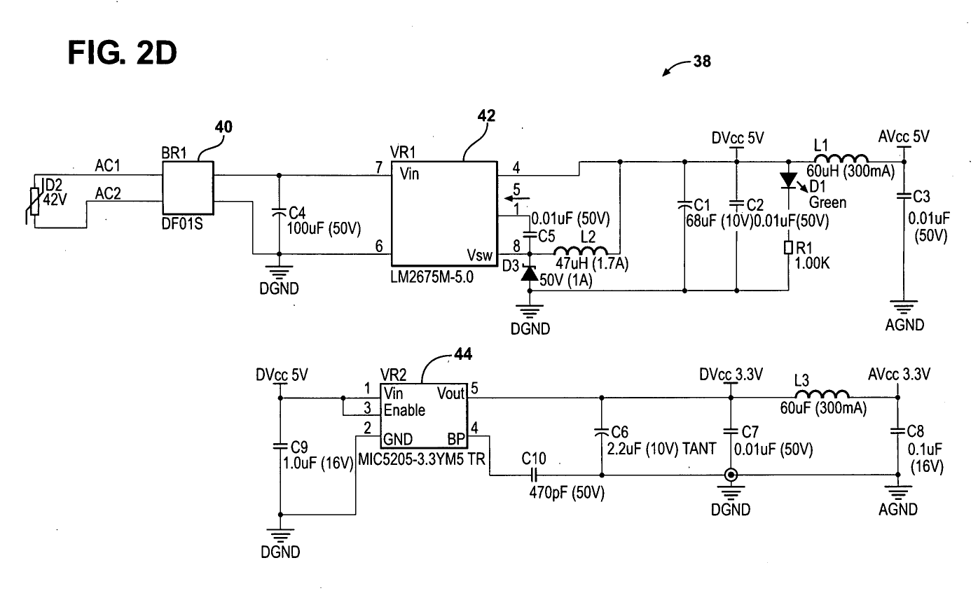

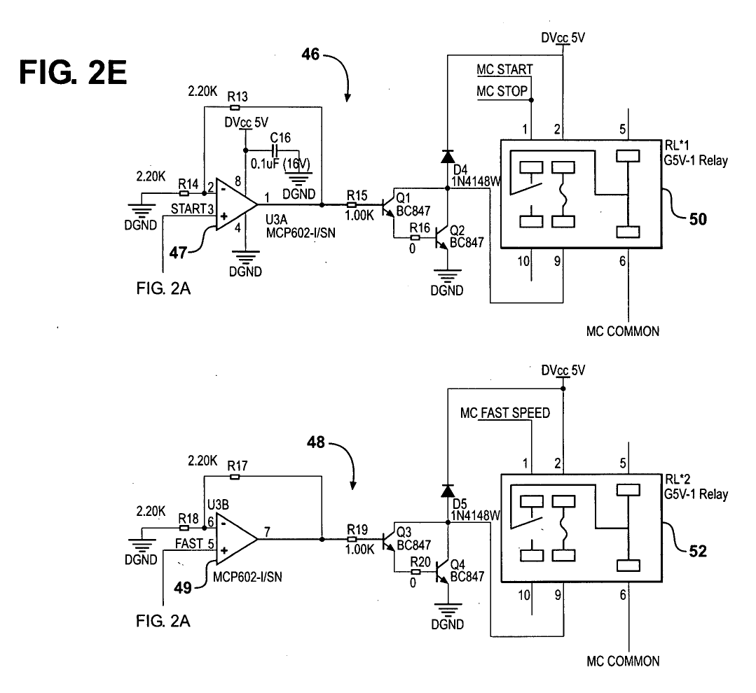

Specifically, in the preferred embodiment, as shown in FIG. 2A, the constant current circuit 30 includes a pair of operational amplifiers (op-amps) 31, 32, i.e., a first op-amp 31 and a second op-amp 32, and four resistors (not numbered). The constant current circuit 30 is electrically connected to a constant voltage source (not numbered). In the preferred embodiment, the constant voltage source is provided by the processor 20; however, other implementations of the constant voltage source are realizable by those skilled in the art.

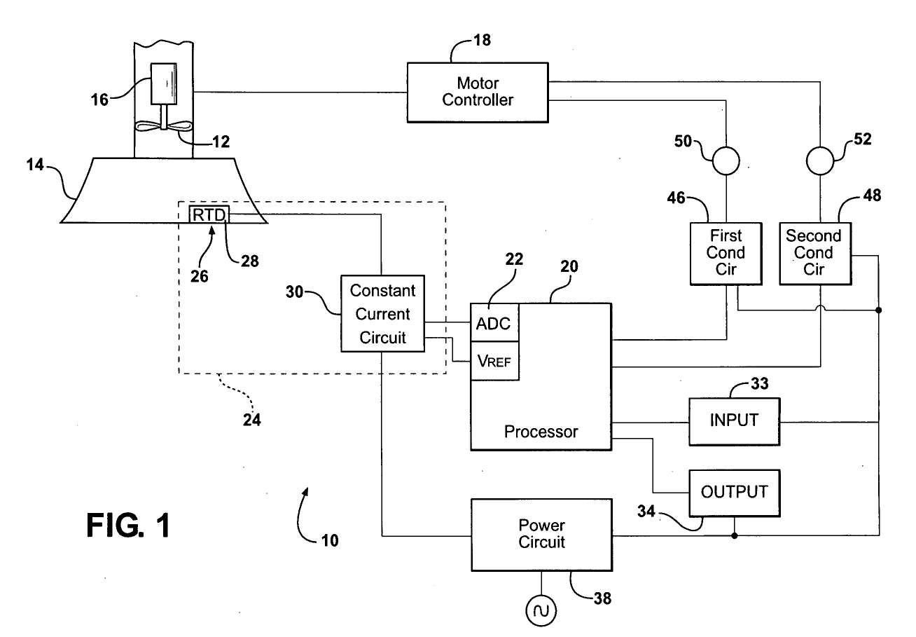

Referring again to FIG. 1, the control system 10 further includes an input device 33 and an output device 34. The input and output devices 33, 34 are each in communication with the processor 20. The input device 33 delivers instructions from a user to the processor 20 while the output device 34 delivers data from the processor 20 to a user.

In the preferred embodiment, as shown in FIG. 2B, the input device 33 is implemented as a plurality of switches 35. In the preferred embodiment, the plurality of switches 35 are three pushbuttons (not separately numbered). The switches 35 are electrically connected to the processor 20. Specifically, the switches 35 are electrically connected to inputs (not numbered) of the processor 20. A user operating the switches 35 is thus able to communicate with the processor 20 and operate various aspects of the control system 10. For instance, the user may communicate setpoints to the processor 20 and manually control the fan 12. Since only three pushbutton switches 35 are utilized in the preferred embodiment, the input device 33 provides a non-confusing interface for the user of the system 10. However, those skilled in the art realize other mechanisms that may be implemented as the input device 33, including, but not limited to, a keyboard, a mouse, a touch screen interface, and a microphone.

As shown in FIG. 2C, the output device 34 of the preferred embodiment is implemented as a display 36 electrically connected to the processor 20. The display 36 displays data sent from the processor 20. The display 36 may be a liquid crystal display (LCD) (not separately numbered) or other type of imaging device known to those skilled in the art. Furthermore, the output device 34 may be implemented using other mechanisms, including, but not limited to, a speaker.

The control system 10 preferably includes a power circuit 38 for supplying electrical power to the various electrical components of the control system 10. More preferably, the power circuit 38 receives AC power and supplies DC power to the various components. Specifically, in the illustrated embodiment shown in FIG. 2D, the power circuit 38 includes a bridge rectifier 40, a 5 volt voltage regulator 42, a 3.3 volt voltage regulator 44, and numerous passive components (not numbered). The power circuit 12 receives 24 VAC power and provides both 5 VDC power and 3.3 VDC power for use by the other components of the control system 10.

The control system 10 preferably includes an output interface 45 for interfacing the processor 20 to the motor controller 18. In the preferred embodiment, as shown in FIG. 2E, the control system 10 includes a first conditioning circuit 46 and a second conditioning circuit 48. The conditioning circuits 46, 48 are electrically connected to outputs (not numbered) of the processor 20. The first conditioning circuit 46 regulates the transition between the first and second speeds of the motor 16 and fan 12. Specifically, the first conditioning circuit 46 is activated by the processor 20 to turn the fan 12 on at the second (low) speed and deactivated to turn the fan 12 off. The second conditioning circuit 48 regulates the transition between the second and third speeds of the motor 16 and fan 12. That is, the second conditioning circuit 48 is activated by the processor 20 to change the speed of the fan 12 from the second (low) speed to the third (high) speed and deactivated to switch back to the second speed.

The first and second conditioning circuits 46, 48 each include, respectively, a first and second op-amp 47, 49. The non-inverting input of each op-amp 47, 49 is electrically connected to separate outputs of the processor 20. A first relay 50 is electrically connected to the first conditioning circuit 46 and a second relay 52 is electrically connected to the second conditioning circuit 48. Specifically, the conditioning circuits 46, 48 are each connected to a coil (not numbered) of the respective relays 50, 52. The motor controller 18 is then electrically connected to the contacts (not numbered) of each relay 50, 52. This allows electrical isolation between the motor controller 18 on one side and the processor 20 and the power circuit 38 on the other side.

The subject invention also includes a method of controlling the air handling fan 12. The method is preferably implemented with the control system 10 described above. However, those skilled in the art realize that alternative techniques for implementing the method may be utilized.

The method includes the steps of receiving temperature setpoints from a user and storing these temperature setpoints in a memory (not shown) of the processor 20. In the preferred embodiment, the temperature setpoints include a first temperature setpoint and a second temperature setpoint. The first temperature setpoint corresponds to a temperature at which the speed of the fan 12 is changed from the first speed to the second speed. The second temperature setpoint corresponds to a temperature at which the speed of the fan 12 is changed from the second speed to the third speed.

The method also includes the steps of receiving at least one temperature deadband range from a user and storing this temperature deadband range in the memory of the processor 20. In the preferred embodiment, the temperature deadband range is a value from 2 degrees Fahrenheit to 99 degrees Fahrenheit. Of course, other values for the temperature deadband range may be utilized in alternate embodiments. Furthermore, other temperature measuring conventions, such as Celsius, may also be utilized.

In the preferred embodiment, the temperature setpoints and temperature deadband range may be received and stored at any time. Therefore, operation of the fan 12 can be changed “on the fly” by the user as a desired operation of the fan 12 changes

The method also preferably computes a first deadband temperature setpoint and a second deadband temperature setpoint. The first deadband temperature setpoint is based on the first temperature setpoint and the temperature deadband range while the second deadband temperature setpoint is based on the second temperature setpoint and the temperature deadband range. Specifically, in the preferred embodiment, the first deadband temperature setpoint is computed by subtracting the temperature deadband range from the first temperature setpoint. Likewise, in the preferred embodiment, the second deadband temperature setpoint is computed by subtracting the temperature deadband range from the second temperature setpoint. Of course, in other embodiments, the deadband temperature setpoints may be computed by alternate techniques.

The method further includes the step of sensing a temperature of air in the vent hood. As stated above, in the preferred embodiment, an RTD 28, a temperature sensing circuit 24, and an ADC 22 work in concert to provide a sensed temperature to the processor 20. Of course, those skilled in the art realize other suitable techniques to sense the temperature of air.

The sensed temperature may be utilized directly by the processor 20 as the actual temperature of air in the vent hood. However, seemingly random variations, spikes, etc. may occur in the electrical signal received by the processor 20 due to electrical interference or other factors. As such, the system 10 may use one or more techniques to obtain a more accurate temperature of the vent hood. For instance, in the preferred embodiment, transient temperature readings are filtered out of the readings obtained by the RTD 28. Furthermore, in the preferred embodiment, a plurality of temperature readings are averaged to compute the actual temperature of air in the vent hood.

The method also includes the step of determining the current speed of the air handling fan 12. This step may be accomplished using several techniques. In one technique, the speed of the air handling fan 12 is stored in the memory of the processor 20 when the speed of the air handling fan 12 is changed. That is, whatever speed the processor 20 previously ordered for the air handling fan 12 is considered the current speed of the air handling fan 12. In another technique, a current sensor (not shown) is utilized to sense the amount of electrical current applied to the motor. This electric current corresponds to the current speed of the fan 12. In yet another technique, an airflow sensor (not shown) is utilized to sense the amount of air being drawn by the fan 12. The amount of airflow corresponds to the current speed of the fan 12. Of course, other techniques will be recognized by those skilled in the art.

The method progresses based on the current speed of the air handling fan 12. When the current speed of the air handling fan 12 is the first speed, the temperature of the air is compared to the first temperature setpoint. If the temperature of the air is greater than the first temperature setpoint, then the speed of the air handling fan 12 is changed from the first speed to the second speed. Therefore, in the preferred embodiment, when the fan 12 is off, and the temperature exceeds the first setpoint, then fan 12 is turned on at the low speed.

When the current speed of the fan 12 is the second speed, the temperature of the air is compared to the first deadband temperatures setpoint and the second temperature setpoint. If the air temperature is less than the first deadband temperature setpoint, then the speed of the air handling fan 12 is changed from the second speed to the first speed. If the air temperature is greater than the second temperature setpoint, then the speed of the air handling fan 12 is changed from the second speed to the third speed. Said another way, if the air temperature rises past the second temperature setpoint, the fan 12 speed increases to the high speed while if the air temperature declines lower than the first deadband temperature setpoint, then the fan 12 is turned off. Otherwise, when the air temperature is between the first deadband temperature setpoint and the second temperature setpoint, the fan 12 continues to operate at the low speed.

When the current speed of the fan 12 is the third speed, the temperature of air is compared to the second deadband temperature setpoint. If the air temperature is less than the second deadband temperature setpoint, then the speed of the air handling fan 12 is changed from the third speed to the second speed. That is, if the air temperature falls lower than the second deadband temperature setpoint, then the fan 12 speed decreases to the low speed.

By utilizing the deadband temperature setpoints, which, in the preferred embodiment, are lower than the corresponding temperature setpoints, the method prevents fast switching of speeds of the fan 12 based on sudden drops in temperature of only one or two degrees. As such, wear and tear on the motor 16, motor controller 18, and relays 50, 52. Furthermore, the annoyance to a user of hearing the fan 12 frequently change speeds is also reduced.

The present invention has been described herein in an illustrative manner, and it is to be understood that the terminology that has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A method of controlling an air handling fan for a vent hood, the fan having at least a first speed and a second speed, said method comprising:
receiving a first temperature setpoint from a user corresponding to a temperature at which the speed of the fan is changed from the first speed to the second speed;
storing the first temperature setpoint in a memory;
receiving a first temperature deadband range from a user;
storing the first temperature deadband range in the memory;
obtaining a temperature of air in the vent hood;
comparing the temperature of air to the first temperature setpoint;
changing the speed of the air handling fan from the first speed to the second speed in response to the temperature of air being greater than the first temperature setpoint;
computing a first deadband temperature setpoint based on the first temperature setpoint and the temperature deadband range; and
changing the speed of the air handling fan from the second speed to the first speed in response to the temperature of air being less than the first deadband temperature setpoint.

2. A method as set forth in claim 1 wherein said step of computing the first deadband temperature setpoint is further defined as subtracting the temperature deadband range from the first temperature setpoint to determine the first deadband temperature setpoint.

3. A method as set forth in claim 1 wherein said step of sensing a temperature of air in the vent hood is further defined as computing the temperature of air by averaging a plurality of temperature readings received from a temperature sensor.

4. A method as set forth in claim 3 further comprising the step of filtering transient temperature readings from the plurality of temperature readings.

5. A method as set forth in claim 1 wherein the fan further includes a third speed and said method further comprises the steps of:
receiving a second temperature setpoint from a user corresponding to a temperature at which the speed of the fan is changed from the second speed to the third speed;
storing the second temperature setpoint in the memory;
comparing the temperature of air to the second temperature setpoint in response to the fan operating at the second speed; and
changing the speed of the air handling fan from the second speed to the third speed in response to the temperature of air being greater than the second temperature setpoint.

6. A method as set forth in claim 5 further comprising the steps of:
computing a second deadband temperature setpoint based on the second temperature setpoint and the temperature deadband range; and
changing the speed of the air handling fan from the third speed to the second speed in response to the temperature of air being less than the second deadband temperature setpoint.

7. A method as set forth in claim 6 wherein the third speed of the fan is faster than the second speed and the second speed is faster than the first speed.

8. A method as set forth in claim 1 wherein the temperature deadband range setpoint is between 2° F. and 99° F.

9. A method as set forth in claim 8 wherein the temperature deadband range setpoint may be set at any time during operation of the air handling fan.

10. A control system for controlling a fan of a vent hood, said system comprising:
an electric motor operatively connected to the fan for turning the fan to generate an air flow;
a variable speed drive connected to said electric motor for controlling the application of electric current to said electric motor at a plurality of speeds;
a temperature sensor for determining a temperature of air in the vent hood;
an input device for receiving a first temperature setpoint and a first temperature deadband range from a user; and
a processor in communication with said input device, said temperature sensor, and said motor controller and adapted to compute a first temperature deadband setpoint based on said first temperature setpoint and said first temperature deadband range and to change the speed of the air handling fan based on the temperature of air in the vent hood, the first temperature setpoint, and the first temperature deadband setpoint.

11. A control system as set forth in claim 10 wherein said temperature sensor is further defined as a resistance temperature detector (RTD).

12. A control system as set forth in claim 11 further comprising a constant current circuit electrically connected to said RTD for providing a constant current to said RTD.

13. A control system as set forth in claim 12 further comprising an analog-to-digital converter (ADC) in communication with said processor and said RTD for providing digital data to said processor corresponding to an analog temperature signal received from said RTD.
